(19) United States
(12) Patent Application Publication
(10) Pub. No.: US 2026/0319986 A1
(43) Pub. Date: Oct. 15, 2026

(54) STORAGE DEVICE AND ELECTRONIC DEVICE SUPPORTING DISAGGREGATED COMPUTING

(71) Applicants: Panmnesia Inc., Daejeon (KR); KOREA ADVANCED INSTITUTE OF SCIENCE AND TECHNOLOGY, Daejeon (KR)

(72) Inventors: Mi Ryeong KWON, Daejeon (KR); Dong Hyun GOUK, Daejeon (KR); Eun Jee NA, Daejeon (KR); Ji Seon KIM, Daejeon (KR); Jun Hee KIM, Daejeon (KR); Hye In WOO, Daejeon (KR); Eo Jin RYU, Daejeon (KR); Hyun Kyu CHOI, Daejeon (KR); Jin Woo BAEK, Daejeon (KR); Han Yeo Reum BAE, Daejeon (KR); Myoung Soo JUNG, Daejeon (KR)

(73) Assignees: Panmnesia Inc., Daejeon (KR); KOREA ADVANCED INSTITUTE OF SCIENCE AND TECHNOLOGY, Daejeon (KR)

(21) Appl. No.: 19/645,263

(22) Filed: Apr. 12, 2026

(30) Foreign Application Priority Data
Apr. 11, 2025 (KR) 10-2025-0047695
Mar. 19, 2026 (KR) 10-2026-0049377

(51) Int. Cl. G06F 13/38; G06F 13/40; H04L 67/1097

(52) U.S. Cl. CPC G06F 13/387; G06F 13/4022; H04L 67/1097

(57) ABSTRACT

A storage device includes a non-volatile memory, a storage controller configured to control the non-volatile memory, a storage interface configured to receive an assigned Internet protocol (IP) address and receive a network packet destined for the assigned IP address, and a computation processor configured to perform application computation corresponding to the network packet using the non-volatile memory.

### CROSS-REFERENCE TO RELATED APPLICATION

This application is based on and claims priority under 35 U.S.C. § 119 to Korean Patent Application No. 10-2025-0047695, filed on Apr. 11, 2025, and Korean Patent Application No. 10-2026-0049377, filed on Mar. 19, 2026, in the Ministry of Intellectual Property, Republic of Korea, the disclosures of which are incorporated by reference herein in their entireties.

### BACKGROUND

### 1. Field

The disclosure relates to a storage device and an electronic device supporting resource-disaggregated computing.

### 2. Description of the Related Art

To minimize overhead caused by the transfer of large amounts of data between electronic devices and storage devices, research has been conducted on in-storage processing (ISP) technology that performs computations directly within the storage devices.

Generally, a storage device that supports in-storage processing may operate in dependence on another physically separate electronic device. As this feature may limit the scalability of the storage device, various approaches have been considered to use storage devices supporting in-storage processing.

### SUMMARY

Provided are a storage device and an electronic device that enables the storage device to be expanded for use as an independent compute node on a network.

Additional aspects will be set forth in part in the description which follows and, in part, will be apparent from the description, or may be learned by practice of the presented embodiments of the disclosure.

According to an aspect of the disclosure, a storage device includes a non-volatile memory, a storage controller configured to control the non-volatile memory, a storage interface configured to receive an assigned Internet protocol (IP) address and receive a network packet destined for the assigned IP address, and a computation processor configured to perform application computation corresponding to the network packet using the non-volatile memory.

In the storage device according to an aspect of the disclosure, the network packet may be generated by an electronic device by converting an Ethernet protocol packet destined for the IP address into a non-volatile memory express (NVMe) protocol format.

The computation processor of the storage device according to an aspect of the disclosure may be further configured to drive a virtualized container environment and perform the application computation in the virtualized container environment.

The computation processor of the storage device according to an aspect of the disclosure may be further configured to generate log data representing a state of the application computation and transmit the log data to an electronic device.

The storage device according to an aspect of the disclosure may be included in a storage pool together with at least one other storage device connected to an electronic device.

The storage device according to an aspect of the disclosure may be connected to the electronic device via a switch, and the at least one other storage device may be connected to the electronic device via the switch.

In the storage device according to an aspect of the disclosure, the application computation may include attention-based computation, and the computation processor may be further configured to store, in the non-volatile memory, a key and a value generated during execution of the application computation.

According to another aspect of the disclosure, an electronic device includes an interface configured to communicate with a plurality of storage devices and a processor configured to assign a unique Internet protocol (IP) address to each of the plurality of storage devices, generate a network packet instructing execution of application computation by any one of the plurality of storage devices, and transmit the network packet to any one of the plurality of storage devices via the interface.

The processor of the electronic device according to another aspect of the disclosure may be further configured to generate the network packet by converting an Ethernet protocol packet destined for the IP address into a non-volatile memory express (NVMe) protocol format.

The processor of the electronic device according to another aspect of the disclosure may be further configured to drive a distributed computing framework to manage each of the plurality of storage devices as an independent compute node and to generate the network packet to execute the application computation in a virtualized container of each of the plurality of storage devices.

The processor of the electronic device according to another aspect of the disclosure may be further configured to receive log data indicating a state of the application computation from each of the plurality of storage devices and monitor the state of the application computation executed in each of the plurality of storage devices based on the log data.

The electronic device according to another aspect of the disclosure may be connected to the plurality of storage devices via at least one switch.

In the electronic device according to another aspect of the disclosure, the network packet may instruct any one of the plurality of storage devices to perform attention-based computation and to store a key and a value generated during execution of the application computation therein.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of a storage system according to an embodiment;

FIG. 2 is a block diagram of a detailed structure of an electronic device and a storage device according to an embodiment;

FIG. 3 is a diagram showing assignment of Internet protocol (IP) addresses to a plurality of storage devices by an electronic device according to an embodiment;

FIG. 4 is a diagram showing cache management when an electronic device and a storage device according to an embodiment perform attention-based computation;

FIG. 5 is a flowchart of an operating method of a storage device according to an embodiment;

FIG. 6 is a flowchart of an operating method of an electronic device according to an embodiment; and

FIG. 7 is a flowchart of an operating method of a storage system according to an embodiment.

### DETAILED DESCRIPTION

Reference will now be made in detail to embodiments, examples of which are illustrated in the accompanying drawings, wherein like reference numerals refer to like elements throughout. In this regard, the current embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Hereinafter, embodiments will be described in detail with reference to the accompanying drawings.

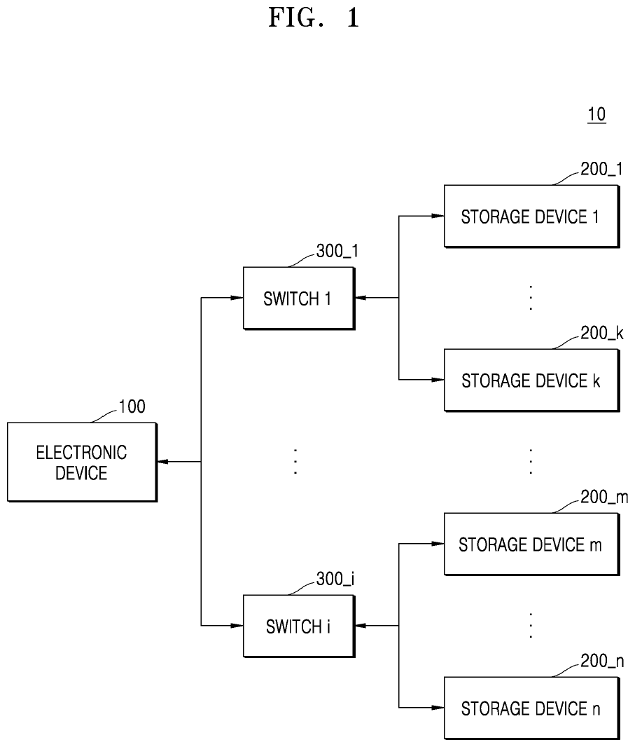

FIG. 1 is a block diagram of a storage system according to an embodiment.

Referring to FIG. 1, a storage system 10 according to an embodiment may include an electronic device 100, a plurality of storage devices 200_1 to 200_n (where n is a natural number), and a plurality of switches 300_1 to 300_i (where i is a natural number).

The storage system 10 may be a computing system capable of performing various types of computations stored therein. For example, the storage system 10 may be included in a computer, a server, a data center, etc.

The electronic device 100 may be a device that performs computation required by the storage system 10. For example, the electronic device 100 may be any one of a host device, a network server device, a chassis management device, etc., but the disclosure is not limited thereto. When the electronic device 100 is a host device, the host device may be any one of devices such as a central processing unit (CPU), a graphics processing unit (GPU), or a neural processing unit (NPU), but the disclosure is not limited thereto.

The plurality of storage devices 200_1 to 200_n may store data therein based on a request received from the electronic device 100. For example, the storage device 200 may be any one of devices such as a solid-state drive (SSD).

The plurality of storage devices 200_1 to 200_n may perform in-storage processing (ISP) operations. The plurality of storage devices 200_1 to 200_n may independently process computation corresponding to commands received from the electronic device 100 and transmit results of such processing to the electronic device 100.

The plurality of switches 300_1 to 300_i may connect the electronic device 100 to the plurality of storage devices 200_1 to 200_n. In other words, each of the plurality of storage devices 200_1 to 200_n may be connected to the electronic device 100 via any one of the plurality of switches 300_1 to 300_i. The electronic device 100 may be connected to the plurality of storage devices 200_1 to 200_n via the plurality of switches 300_1 to 300_i.

In the embodiment shown in FIG. 1, a first switch 300_1 may connect a first storage device 200_1 to a k^{th} storage device 200_k (where k is a natural number of 2 or greater) to the electronic device 100. An i^{th} switch 300_i may connect an m^{th} storage device 200_m (where m is a natural number greater than k and less than n) through an n^{th} storage device 200_n to the electronic device 100. However, the disclosure is not limited thereto, and it is acceptable for the storage system 10 to include the first switch 300_1, with all of the plurality of storage devices 200_1 to 200_n connected to the electronic device 100 via the first switch 300_1.

In an embodiment, the storage system 10 may be physically implemented within a single chassis or a plurality of chassis systems. In this case, the plurality of switches 300_1 to 300_i may be mounted in a network region of a chassis in the form of a modular switch tray, and the plurality of storage devices 200_1 to 200_n may be mounted in a storage slot region of the chassis.

In an embodiment, the plurality of storage devices 200_1 to 200_n may constitute a storage pool. Each of the plurality of storage devices 200_1 to 200_n included in the storage pool may operate as a mutually independent compute node that is separate from the electronic device 100.

According to this storage pool configuration, in a large-scale computing environment that requires massive memory capacity and multi-node parallel processing performance, such as distributed inference for large language models (LLMs), the electronic device 100 may flexibly distribute computational load across several storage devices within the storage pool via network packets to perform parallel processing. In this way, centralized computation and memory bottlenecks in the electronic device 100 may be alleviated, and scalability and data processing efficiency of the entire large-scale distributed computing system may be maximized.

In an embodiment, the electronic device 100 may assign a unique IP address to each of the plurality of storage devices 200_1 to 200_n. The electronic device 100 may generate and transmit a network packet instructing one of the plurality of storage devices 200_1 to 200_n to perform application computation.

In an embodiment, each of the plurality of storage devices 200_1 to 200_n may perform application computation corresponding to network packets received from the electronic device 100.

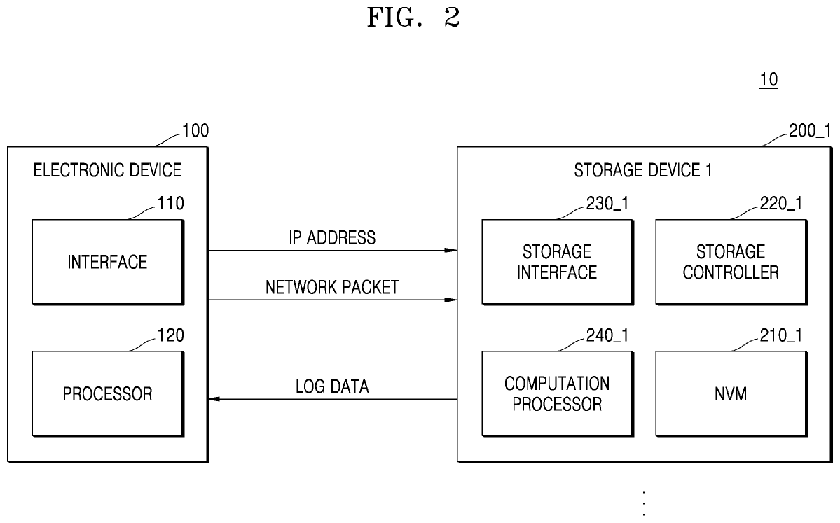

More detailed structures and operations of the electronic device 100 and the plurality of storage devices 200_1 to 200_n will be described with reference to FIG. 2 and subsequent drawings.

FIG. 2 is a block diagram of a detailed structure of an electronic device and a storage device according to an embodiment.

Referring to FIG. 2, the storage system 10 according to an embodiment may include the electronic device 100 and the plurality of storage devices 200_1 to 200_n. Due to the limitations of the drawing, the first storage device 200_1 is shown in FIG. 2 among the plurality of storage devices 200_1 to 200_n, but the other storage devices 200_2 to 200_n not shown in FIG. 2 may have the same structure as the first storage device 200_1. Although not shown in FIG. 2, the electronic device 100 may be connected to the storage device 200 via any one of the plurality of switches 300_1 to 300_i shown in FIG. 1.

The electronic device 100 may include an interface 110 and a processor 120.

The interface 110 may communicate with the plurality of storage devices 200_1 to 200_n. The interface 110 may allow the electronic device 100 to communicate with the plurality of storage devices 200_1 to 200_n via any one of the plurality of switches 300_1 to 300_i.

The interface 110 may provide a communication path for performing communication with the plurality of storage devices 200_1 to 200_n. In an embodiment, the interface 110 may be an interface based on a peripheral component interconnect express (PCIe).

In an embodiment, the interface 110 may transmit the IP address, assigned by the processor 120 to each of the plurality of storage devices 200_1 to 200_n, to each of the plurality of storage devices 200_1 to 200_n. In addition, the interface 110 may transmit a network packet generated by the processor 120 to any one of a plurality of storage devices 200_1 to 200_n.

The processor 120 may control overall operations of the electronic device 100.

In an embodiment, the processor 120 may assign a unique IP address to each of the plurality of storage devices 200_1 to 200_n. An IP address may be used to distinguish the plurality of storage devices 200_1 to 200_n from each other, and the IP address assigned to each of the plurality of storage devices 200_1 to 200_n may all be different. As such, each of the plurality of storage devices 200_1 to 200_n may be assigned a unique IP address, thereby operating as an independent network node.

In an embodiment, the processor 120 may generate a network packet instructing one of the plurality of storage devices 200_1 to 200_n to perform application computation. The processor 120 may generate a network packet by converting an Ethernet protocol packet destined for an IP address assigned to one of the plurality of storage devices 200_1 to 200_n into a non-volatile memory express (NVMe) protocol format.

A network packet may include an IP address of a destination among the plurality of storage devices 200_1 to 200_n, a control command instructing execution of application computation to be processed by a destination storage device, and related data.

In an embodiment, the processor 120 may run a distributed computing framework (e.g., Kubernetes, Docker-compose, etc.) to manage the plurality of storage devices 200_1 to 200_n as independent compute nodes. The processor 120 may generate a network packet to enable application computation to be performed within a virtualized container in each of the plurality of storage devices 200_1 to 200_n.

In an embodiment, for the distributed processing of large-scale applications such as an LLM, the processor 120 may generate a network packet instructing one of a plurality of computations included in the LLM to be executed in a virtualized container environment provided within each of the plurality of storage devices 200_1 to 200_n. The processor 120 may also instruct a key and a value generated during execution of any one of the plurality of computations included in the LLM to be stored in each of the plurality of storage devices 200_1 to 200_n.

In an embodiment, the processor 120 may receive log data (e.g., a standard output (stdout), a standard error (stderr), etc.) representing a state of application computation from each of the plurality of storage devices 200_1 to 200_n. The processor 120 may monitor the state of application computation running on each of the plurality of storage devices 200_1 to 200_n based on the log data.

The first storage device 200_1 may include NVM 210_1, a storage controller 220_1, a storage interface 230_1, and a computation processor 240_1.

The NVM 210_1 may store data requested by the electronic device 100. Furthermore, when the first storage device 200_1 performs in-storage processing operations, the NVM 210_1 may store intermediate computational data, such as cache data, generated during the execution of the in-storage processing operations.

The storage controller 220_1 may control an operation of the NVM 210_1. The storage controller 220_1 may control an operation to store data in the NVM 210_1 or read data from the NVM 210_1.

The storage interface 230_1 may provide a communication path for communicating with the electronic device 100.

In an embodiment, the storage interface 230_1 may receive an IP address assigned by the electronic device 100. The storage interface 230_1 may also receive a network packet destined for the assigned IP address. A network packet may be an Ethernet protocol packet converted into an NVMe protocol format, and the storage interface 230_1 may transmit the same to the computation processor 240_1.

In an embodiment, the computation processor 240_1 may perform application computation corresponding to the network packet using the NVM 210_1.

Specifically, the computation processor 240_1 may run a virtualized container environment (e.g., a Docker-based container) in the first storage device 200_1 based on virtual firmware that supports lightweight operating system-level virtualization (operating system (OS)-level virtualization). The computation processor 240_1 may parse the network packet received via the storage interface 230_1 and independently execute application computation specified by the network packet in the running virtualized container.

In an embodiment, the computation processor 240_1 may generate log data representing a state of application computation. The computation processor 240_1 may transmit the log data to the electronic device 100, thereby enabling the electronic device 100 to monitor a computation state in the first storage device 200_1 in real time.

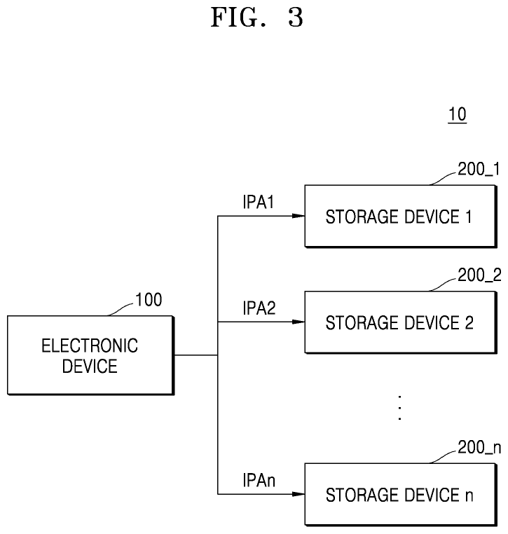

FIG. 3 is a diagram showing assignment of IP addresses to a plurality of storage devices by an electronic device according to an embodiment.

Referring to FIG. 3, it may be seen that the electronic device 100 of the storage system 10 is capable of transmitting an IP address to each of the plurality of storage devices 200_1 to 200_n.

The electronic device 100 may assign unique IP addresses IPA1 to IPAn to the plurality of storage devices 200_1 to 200_n, respectively. In the embodiment shown in FIG. 3, the electronic device 100 may assign a first IP address IPA1 to the first storage device 200_1 and transmit the first IP address IPA1 to the first storage device 200_1. The electronic device 100 may assign a second IP address IPA2 to the second storage device 200_2 and transmit the second IP address IPA2 to the second storage device 200_2. In the same manner as above, the electronic device 100 may assign an n^{th} IP address IPAn to the n^{th} storage device 200_n and transmit the n^{th} IP address IPAn to the n^{th} storage device 200_n.

In this way, in the storage system 10 according to an embodiment, the electronic device 100 may assign a unique IP address to each of the plurality of storage devices 200_1 to 200_n and transmit a network packet destined for the IP address, thereby enabling each of the plurality of storage devices 200_1 to 200_n to operate as an independent compute node.

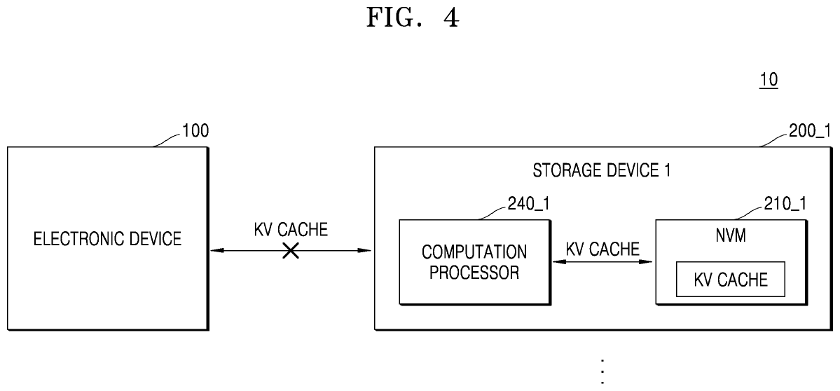

FIG. 4 is a diagram showing cache management when an electronic device and a storage device according to an embodiment perform attention-based computation.

Referring to FIG. 4, when the electronic device 100 and the plurality of storage devices 200_1 to 200_n perform computation included in the LLM, movement of a key-value (KV) cache may be detected.

In a typical LLM distributed inference environment, a KV cache including key and value data containing information about previous tokens may be stored during attention computation. The stored KV cache may be reused during attention computation for subsequent tokens, thereby improving computational efficiency.

In an embodiment, the computation processor 240_1 of the first storage device 200_1 may perform attention-based computation as part of application computation in response to receiving a network packet from the electronic device 100. For example, attention-based computation may be any one of a plurality of computations included in an LLM. The computation processor 240_1 may store the KV cache generated during a computation process in the NVM 210_1 and may read the KV cache stored in the NVM 210_1. Although omitted from the drawing, the computation processor 240_1 may store the KV cache in the NVM 210_1 via the storage controller 220_1, and may read the KV cache from the NVM 210_1 via the storage controller 220_1.

In this case, KV cache transfer may not be performed between the electronic device 100 and the first storage device 200_1. This allows application computation having large-capacity requirements to be performed with reduced data transfer, thereby improving the processing performance of the entire storage system 10.

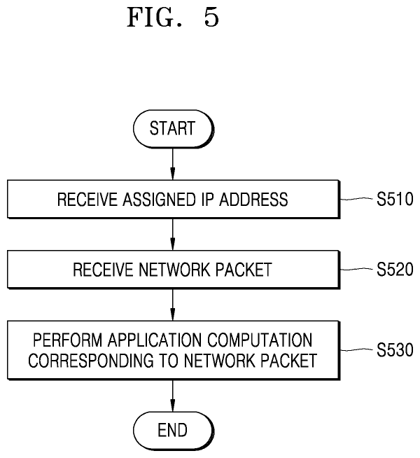

FIG. 5 is a flowchart of an operating method of a storage device according to an embodiment.

Referring to FIG. 5, an operating method of any one of the plurality of storage devices 200_1 to 200_n may be identified.

In operation S510, the storage device may receive a unique IP address assigned by the electronic device 100. An IP address may be set differently for each of the plurality of storage devices 200_1 to 200_n, enabling the storage devices to operate as an independent network node.

In operation S520, the storage device may receive a network packet from the electronic device 100. A network packet may be generated by converting an Ethernet protocol packet destined for an IP address assigned to one of the plurality of storage devices 200_1 to 200_n by the electronic device 100 into the NVMe protocol format.

In operation S530, the storage device may perform application computation corresponding to the received network packet. The storage device may run a virtualized container environment via an internal computation processor and may independently execute application computation in the virtualized container environment based on a control command and data contained in the network packet.

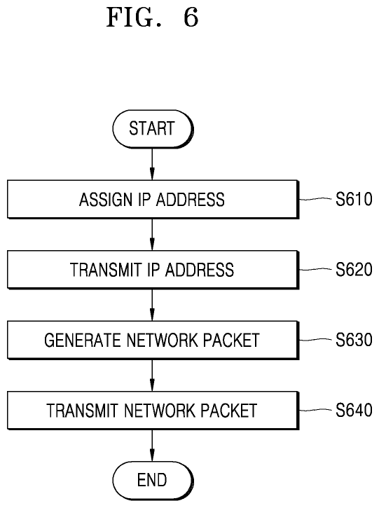

FIG. 6 is a flowchart of an operating method of an electronic device according to an embodiment.

Referring to FIG. 6, in operation S610, the electronic device 100 may assign an IP address to each of the plurality of connected storage devices 200_1 to 200_n. The electronic device 100 may assign a different IP address to each of the plurality of storage devices 200_1 to 200_n.

In operation S620, the electronic device 100 may transmit the assigned IP address to the corresponding storage device.

In operation S630, the electronic device 100 may generate a network packet. A network packet may instruct any one of the plurality of storage devices 200_1 to 200_n to perform application computation

In operation S640, the electronic device 100 may transmit the generated network packet to the corresponding storage device via a physical interface.

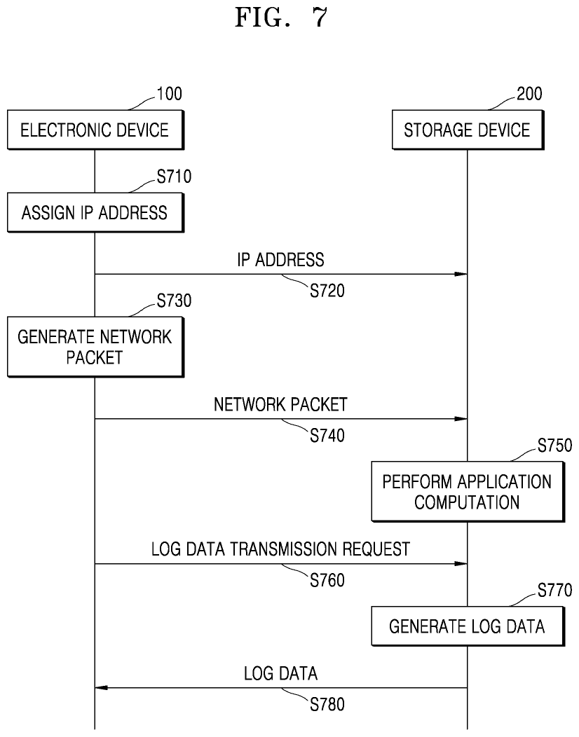

FIG. 7 is a flowchart of an operating method of a storage system according to an embodiment.

Referring to FIG. 7, in operation S710, the electronic device 100 may assign an IP address to the storage device 200. This corresponds to operation S610 of FIG. 6.

In operation S720, the electronic device 100 may transmit the assigned IP address to the storage device 200, and the storage device 200 may receive the assigned IP address. This corresponds to operation S620 of FIG. 6 and operation S510 of FIG. 5.

In operation S730, the electronic device 100 may generate a network packet. This corresponds to operation S630 of FIG. 6.

In operation S740, the electronic device 100 may transmit the generated network packet to the storage device 200, and the storage device 200 may receive the network packet. This corresponds to operation S640 of FIG. 6 and operation S520 of FIG. 5.

In operation S750, the storage device 200 may perform application computation corresponding to the received network packet in response to receiving the network packet from the electronic device 100. This corresponds to operation S530 of FIG. 5.

In operation S760, the electronic device 100 may transmit a log data transmission request to the storage device 200.

In operation S770, the storage device 200 may generate log data representing an execution state of application computation in response to receiving the log data transmission request from the electronic device 100.

In operation S780, the storage device 200 may transmit the generated log data to the electronic device 100.

Although FIG. 7 shows an embodiment in which the storage device 200 generates log data in response to a log data transmission request from the electronic device 100 and transmits the log data to the electronic device 100, the disclosure is not limited thereto. Unlike the embodiment shown in FIG. 7, the storage device 200 may be configured to periodically generate the log data and transmit the log data to the electronic device 100, regardless of reception of the log data transmission request from the electronic device 100.

As above, embodiments have been disclosed in the drawings and specifications. Although the embodiments have been described using specific terms herein, they are merely used for the purpose of explaining the technical idea of the disclosure, and are not used to limit the scope of the disclosure described in the claims. It would be fully understood by those of ordinary skill in the art that various modifications and other equivalent embodiments are possible from the embodiments. Accordingly, the true technical scope of the disclosure should be defined by the technical spirit of the appended claims.

According to the technical spirit of the disclosure, the electronic device may allocate IP addresses to the plurality of storage devices and transmit network packets destined for the IP addresses, allowing each of the plurality of storage devices to operate as an independent compute node.

Furthermore, according to the technical concept of the disclosure, the processing performance of the entire storage system may be improved by connecting a plurality of storage devices via at least one switch.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. A storage device comprising:
a non-volatile memory;
a storage controller configured to control the non-volatile memory;
a storage interface configured to receive an assigned Internet protocol (IP) address and receive a network packet destined for the assigned IP address; and
a computation processor configured to perform application computation corresponding to the network packet using the non-volatile memory.

2. The storage device of claim 1, wherein the network packet is generated by an electronic device by converting an Ethernet protocol packet destined for the IP address into a non-volatile memory express (NVMe) protocol format.

3. The storage device of claim 1, wherein the computation processor is further configured to drive a virtualized container environment and perform the application computation in the virtualized container environment.

4. The storage device of claim 1, wherein the computation processor is further configured to generate log data representing a state of the application computation and transmit the log data to an electronic device.

5. The storage device of claim 1, wherein the storage device is included in a storage pool together with at least one other storage device connected to an electronic device.

6. The storage device of claim 5, wherein the storage device is connected to the electronic device via a switch, and
the at least one other storage device is connected to the electronic device via the switch.

7. The storage device of claim 1, wherein the application computation comprises attention-based computation, and
the computation processor is further configured to store, in the non-volatile memory, a key and a value generated during execution of the application computation.

8. An electronic device comprising:
an interface configured to communicate with a plurality of storage devices; and
a processor configured to assign a unique Internet protocol (IP) address to each of the plurality of storage devices, generate a network packet instructing execution of application computation by any one of the plurality of storage devices, and transmit the network packet to any one of the plurality of storage devices via the interface.

9. The electronic device of claim 8, wherein the processor is further configured to generate the network packet by converting an Ethernet protocol packet destined for the IP address into a non-volatile memory express (NVMe) protocol format.

10. The electronic device of claim 8, wherein the processor is further configured to drive a distributed computing framework to manage each of the plurality of storage devices as an independent compute node and to generate the network packet to execute the application computation in a virtualized container of each of the plurality of storage devices.

11. The electronic device of claim 10, wherein the processor is further configured to receive log data indicating a state of the application computation from each of the plurality of storage devices and monitor the state of the application computation executed in each of the plurality of storage devices based on the log data.

12. The electronic device of claim 8, wherein the electronic device is connected to the plurality of storage devices via at least one switch.

13. The electronic device of claim 8, wherein the network packet instructs any one of the plurality of storage devices to perform attention-based computation and to store a key and a value generated during execution of the application computation therein.
